(19) United States
(12) Patent Application Publication
(10) Pub. No.: US 2005/0119056 A1
(43) Pub. Date: Jun. 2, 2005

(54) Universal connector structure

(76) Inventor: Shih Lung Chien, Taipei City (TW)

Correspondence Address: CHARLES E. BAXLEY, ESQ., 90 JOHN STREET, THIRD FLOOR, NEW YORK, NY, 10038, US

(21) Appl. No.: 10/724,932

(22) Filed: Dec. 1, 2003

(51) Int. Cl. F16D 3/18

(52) U.S. Cl. 464/158

(57) ABSTRACT

An universal connector structure mainly comprises an initiative piece, a stopping piece and an elastic limitation piece with purposes of being a spring or elastic element, the initiative piece having a concave hole, four concave bodies and four convex bodies are evenly disposed on the concave hole, the stopping piece having an inserting hole for inserting a ball body, four protruded pieces are disposed just under the middle line of the ball body, the protruded pieces are inserted into the convex bodies on the concave hole of the initiative piece, the elastic limitation piece is placed on a concave groove of the concave hole of the initiative piece, accordingly, different angle degrees can be adjusted, a wider range of angle degrees can be achieved, torque is maximized, and production cost is reduced, the structure is more stable to withstand optimum torque.

### BACKGROUND OF THE INVENTION

Referring to FIG. 1, shows a conventional universal structure comprises an initiative piece having a rectangular hole (1), a stopping piece with its head in round shape, but also having 4 angles (2) formed by its four sides. So that the stopping piece head can move within the rectangular hole (1) and can also lock inside the rectangular hole (1), thus-different angles can be adjusted and can also create torque. The drawback is the angle being adjusted is very limited based on the structural mechanism of the rectangular hole (1) and the round head with four angular sides.

Referring to FIG. 2, which is another conventional connector structure, comprises an initiative piece (6) with a concave hole (7) disposed on one end. A stopping piece (8) with one end formed in a ball body (9). The ball body (9) is inserted into the concave hole (7) for adjusting different angles. A hole (9b) is disposed on the ball body (9) for a bar (9a) to go through and connect to the concave hole (7) of the initiative piece (6). Thus a wider degree of angles cab be adjusted but its drawback is that, the bar cannot withstand torque of optimum value and will easily break.

Referring to FIG. 3, another conventional type of universal connector structure. It mainly comprises an initiative piece (3), a connecting piece (4) and a stopping piece (5). The initiative piece (3) having a locking piece (3a) disposed on one end. A bar (4a) is used to connect the locking piece (4) and the initiative piece (3). An indentation (3b) is formed on the initiative piece (3) to leave room for adjusting different angles. The stopping piece (5) is connected to the locking piece (4) by a bar (4b). The bar (4b) is perpendicular to the bar (4a). The stopping piece (5) having an inserting hole (5a) disposed on its one end. This conventional universal connector structure uses bars to connect the elements together, same as the previous prior art, the bars cannot withstand optimum torque and will easily break.

Referring to FIG. 4, yet another conventional universal connector structure. It mainly comprises an initiative piece (90) and a stopping head (91). The initiative piece (90) having a hollow hole (92) and 4 protrusions (93) are disposed evenly inside the hollow hole (92). The stopping head (91) also having 4 protruded pieces (94) evenly disposed at its bottom end, the protrude pieces (94) are in round curve shape and are inserted between the protrusions (93) of the initiative piece (90). Thus the stopping head (91) can be adjusted to different angles by the structural mechanism of the protrusions (93) of the initiative piece (90) and the protruded pieces (94) of the stopping head (91). This structure is difficult to manufacture with high production cost.

### SUMMARY OF THE PRESENT INVENTION

The present of an universal connector structure mainly comprises an initiative piece, a stopping piece and an elastic limitation piece. The initiative piece having a concave hole, the concave hole is evenly divided into four concave bodies and four convex bodies. The stopping piece having an inserting hole for inserting a ball body. The ball body having four protruded pieces evenly disposed just under the middle line of the ball body. The protruded pieces of the ball body are inserted between the concave bodies of the concave hole of the initiative piece. The elastic limitation piece is disposed inside the concave hole, used for adjusting different angles of wide degrees, and at the same time can withstand high torque force.

The present invention will become more fully understood by reference to the following detailed description thereof when read in conjunction with the attached drawings.

### BRIEF DESCRIPTION OF THE DRAWINGS

FIG. 1 is a perspective view of a conventional universal connector structure;

FIG. 2 is another perspective view of a conventional universal connector structure;

FIG. 3 is another perspective view of a conventional universal connector structure;

FIG. 4 is another perspective view of a conventional universal connector structure;

FIG. 5 is a perspective exploded view of the present invention of a conventional universal connector structure;

FIG. 6 is a sectional view of the present invention of a conventional universal connector structure;

FIG. 7 is a sectional view of the present invention of a conventional universal connector structure in motion;

FIG. 8 is a sectional view of another embodiment of the present invention of a conventional universal connector structure.

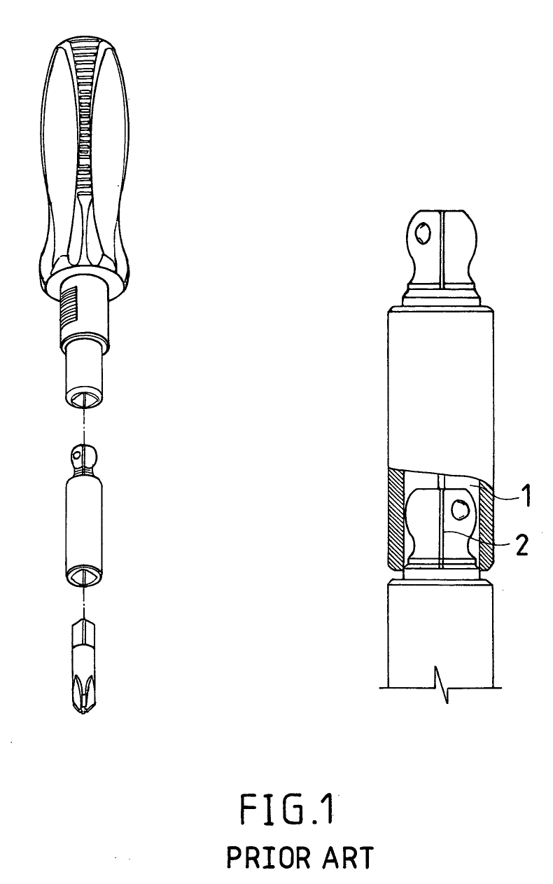

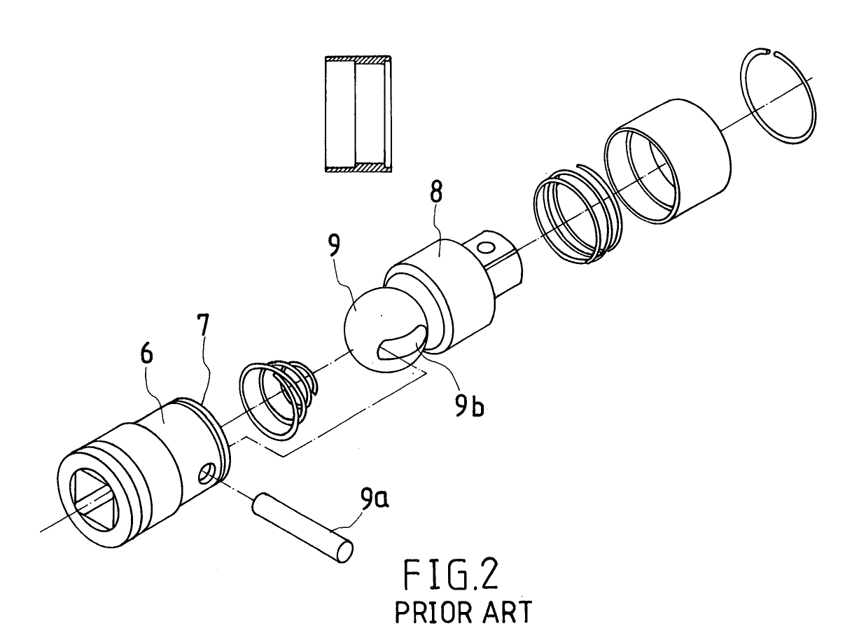

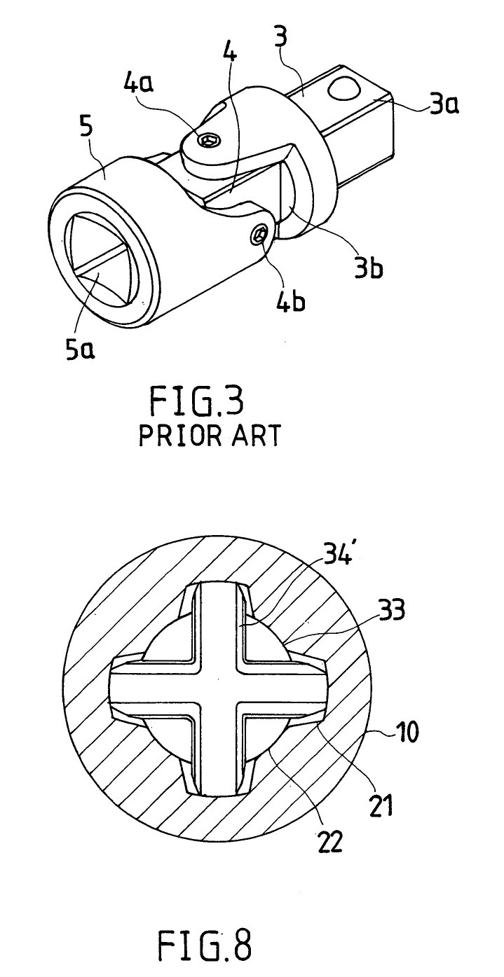

### DETAILED DESCRIPTION OF THE PREFERRED EMBODIMENT

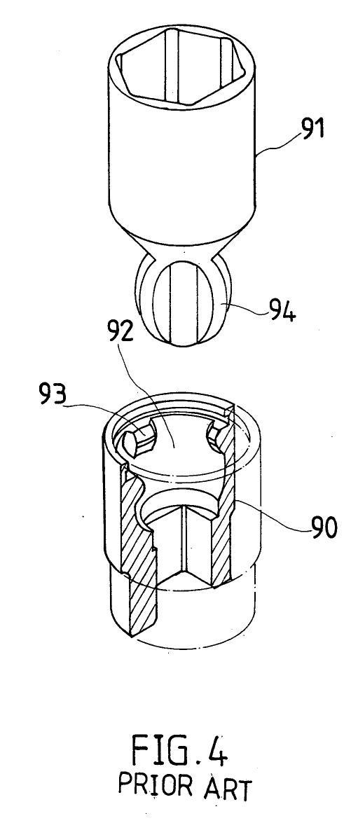

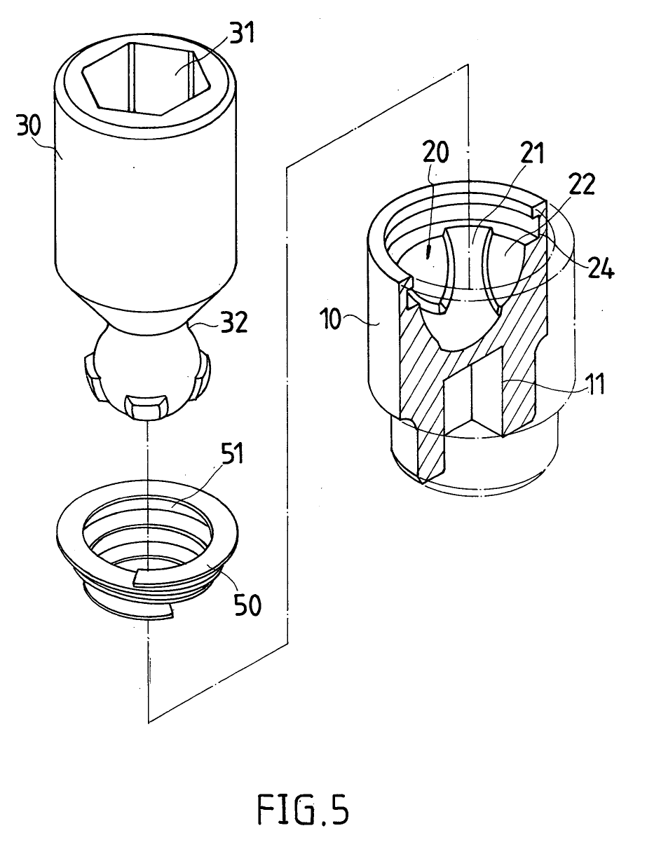

Referring to FIG. 5, the present invention of a conventional universal connector structure mainly comprises an initiative piece (10) having a fitting hole (11) for inserting various types of mechanical or hand tools. Force is applied on the initiative piece (10). The initiative piece (10) also having a concave hole (20) with four concave bodies (21) and four convex bodies (22) disposed evenly inside the concave hole (20). The concave bodies (21) having wider widths at its both ends comparing to the narrow width in the middle.

A stopping piece (30) having a locking hole (31) and a inserting hole (32) at another end. The inserting hole (32) is for inserting a ball body (33). The ball body (33) having four protruded pieces (34) evenly disposed just under the middle line of the ball body (33).

An elastic limitation piece (50) is in spiral shape, or a combination of rubber piece and spring or grommet, or a combination of elastic element and spring or grommet. The elastic limitation piece (50) is inserted into the concave hole (20) of the initiative piece (10) on a circular groove (24) disposed near the periphery of the concave hole (20). An inner hole (51) of the elastic limitation (50) is in contact with the inserting hole (32) of the stopping piece (30).

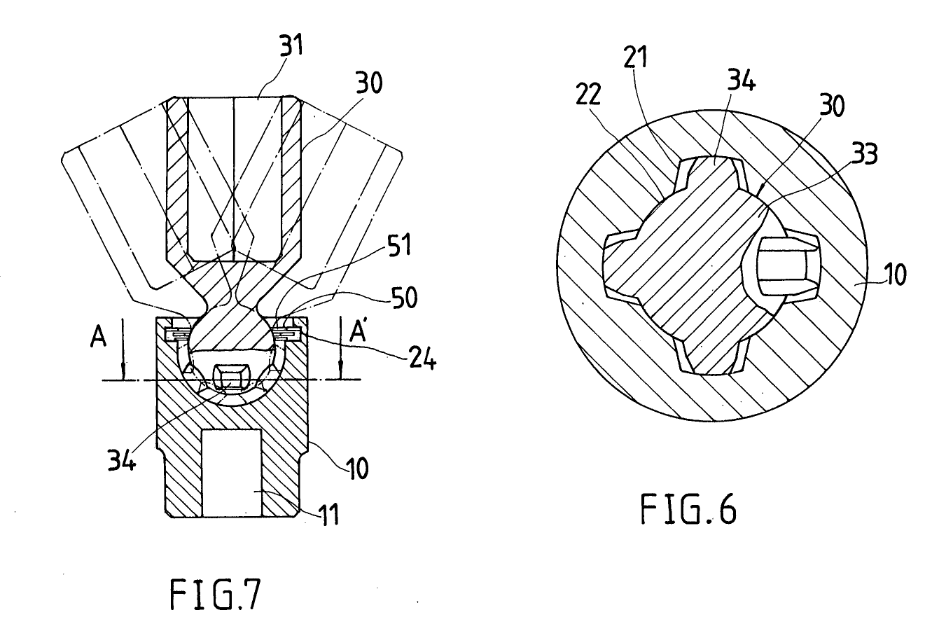

Referring to FIGS. 6 and 7, the ball body (33) of the stopping piece (30) is inserted into the concave hole (20) of the initiative piece (10). So the protruded pieces (34) of the ball body (33) are inserted into the concave bodies (21) of the concave hole (20). While the inner hole (51) of the elastic limitation piece (50) is locked within, between the inserting hole (32) of the stopping piece (30), and the circular groove (24) of the concave hole (20) of the initiative piece (10).

Accordingly, the elastic limitation piece (50) can help stable the angle adjusted by the stopping piece (30). The protruded pieces (34), which are disposed just under the middle line of the ball body (33), are inserted into the concave bodies (21), and because both ends of the concave bodies (21) are wider than the width of its middle, the stopping piece (30) can be adjusted to various angle degrees with 60 degrees the maximum. When the initiative piece (10) is driven by a pneumatic, an electrical tool or a hand tool, the convex bodies (22) are locked with the protruded pieces (34) of the stopping piece (30), so that the force can be passed to the stopping piece (30) through the protruded pieces (34). Thus torque can be transmitted and different degrees of angles can be adjusted.

Referring to FIG. 8, protruded pieces (34′) can be formed as across shape on the ball body (33) of the stopping piece (30), its effectiveness is enhanced because it can withstand optimum torque force.

According to the above structural mechanism of the present invention of an universal connector structure, it has the following advantages:
1. The conventional types cannot be forged in manufacturing process, but use casting instead. They have higher production costs and are weaker in structure to withstand optimum torque. The present invention uses the protruded pieces on the stopping piece, and the concave hole, the concave bodies and the convex bodies on the initiative piece, which all these elements can be forged or use lathe in manufacturing. Thus production cost is reduced and the structure is also strengthened to withstand optimum torque.
2. The present invention uses the convex bodies to drive the protruded pieces, torque is optimized and is more effective than the conventional types using bars for connection.
3. The present invention uses the elastic limitation piece for more stable support and provide a wider range of angle degree for adjusting angles.

Note that the specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

1. An universal connector structure specially designed for tools, it mainly comprises an initiative piece having a fitting hole for inserting various types of mechanical or hand tools, force is transmitted through said initiative piece, a concave hole is disposed at another end of said initiative piece, same number of a plurality of concave bodies and convex bodies are disposed evenly on said concave hole, said concave bodies having wider widths at their both ends, a concave groove is disposed near the periphery of said concave hole;
a stopping piece having a locking hole and an inserting hole at another end for inserting a ball body, said ball body having a plurality of protruded pieces disposed evenly under the middle line of said ball body;
an elastic limitation piece, which is disposed on a concave groove of said concave hole of said initiative piece, said elastic limitation piece having an inner hole which is placed on said inserting hole of said stopping piece;
accordingly, production cost is reduced, torque is enhanced and also having a wider range of angle degree for adjusting.

2. The present invention of an universal connector structure as claimed in claim 1, said elastic limitation piece is in spiral shape, or a combination of rubber piece and spring or grommet, or a combination of elastic element and spring or grommet.

3. The present invention of an universal connector structure as claimed in claim 1, said concave bodies, convex bodies and protruded pieces work best having four pieces each.

4. The present invention of an universal connector structure as claimed in claim 1, said protruded pieces of said stopping piece can be formed as a cross shape on said ball body.
